(19) United States
(12) Patent Application Publication
(10) Pub. No.: US 2019/0282926 A1
(43) Pub. Date: Sep. 19, 2019

(54) SYSTEMS FOR COMPRESSING LOW PRESSURE GASEOUS CO2

(71) Applicant: Waters Technologies Corporation, Milford, MA (US)

(72) Inventors: Steven Stricko, Trafford, PA (US); Glenn Chesney, Monroeville, PA (US); Andrew Sulik, Pittsburgh, PA (US); Michael Webster, Gibsonia, PA (US); Edward J. Ognibene, Belmont, MA (US); Brendan McKinley, Malvern, PA (US); David Sauers, Rural Ridge, PA (US)

(73) Assignee: Waters Technologies Corporation, Milford, MA (US)

(21) Appl. No.: 16/351,753

(22) Filed: Mar. 13, 2019

Related U.S. Application Data
(60) Provisional application No. 62/643,667, filed on Mar. 15, 2018.

(51) Int. Cl. B01D 15/40; G01N 30/02

(52) U.S. Cl. CPC B01D 15/40; B01D 11/0203; G01N 30/02

(57) ABSTRACT

The present disclosure relates to methodologies, systems, and devices for compressing CO₂ for recycling within a CO₂-based chromatography or extraction system. A bellows pump can receive CO₂ in a gaseous state and can compress the CO₂ into a liquid or partially liquid-vapor state using hydraulic compression. Once compressed, the liquid or liquid-vapor CO₂ can be recycled within the CO₂-based chromatography or extraction system.

### RELATED APPLICATION

This application claims priority from and the benefit of U.S. Provisional Patent Application No. 62/643,667 filed on Mar. 15, 2018 and titled SYSTEMS FOR COMPRESSING LOW PRESSURE GASEOUS CO₂, the entire contents of which are incorporated herein by reference.

### FIELD OF THE TECHNOLOGY

The present disclosure generally relates to carbon dioxide (CO₂) based chromatography and extraction systems. In particular, the present disclosure relates to compressors for use in a CO₂ based system.

### BACKGROUND

CO₂ based systems, such as for example, supercritical fluid extraction (SFE) systems and supercritical fluid chromatography systems, extract or separate utilizing supercritical CO₂ instead of an organic solvent. The supercritical fluid state occurs when a fluid is above its critical temperature and critical pressure, when it is between the typical gas and liquid state. Manipulating the temperature and pressure of the fluid can solubilize the material of interest and selectively extract it. Typically in CO₂-based systems, CO₂ is provided in a compressed form from a canister. During the chromatography or extraction process, the CO₂ is generally decompressed into a gaseous state, rather than collected and reused.

### SUMMARY

Recycling CO₂ within CO₂-based chromatography and/or extraction systems raises a number of challenges. Technology for recycling CO₂ in an efficient and compact manner would be beneficial and highly desirable.

In general, certain embodiments of the present technology feature a bellows compressor configured to pressurize CO₂ from a gaseous state to a liquid or partially liquid state. Once compressed to such a state, the liquid or partially liquid CO₂ can be recycled within a CO₂-based chromatography or extraction system. In some embodiments, the bellows can be a stainless steel bellows with fewer seals than a typical piston-based compressor. Reducing the number of seals can increase the lifespan of the system, as compared to a piston-based design. Furthermore, because the bellows acts as a compression chamber, a larger volume of CO₂ can be compressed at one time compared to a piston-based compressor of a similar size.

In one aspect, the present technology relates to an apparatus for compressing a fluid that includes a housing, a bellows disposed within the housing, a fluid inlet line, and a fluid outlet line. The bellows includes a movable wall configured to compress and decompress a fluid between a compression stroke and an inlet stroke. The system can also include a hydraulic fluid disposed within the housing and surrounding an outer surface of the bellows. During an inlet stroke, the hydraulic fluid maintains a pressure differential of less than 25 psi (172.37 kPa) across the movable wall. In a non-limiting example, the fluid is CO₂. In another non-limiting example, the fluid enters the bellows through the inlet line at a gaseous state, and wherein the fluid exits the bellows through the outlet line at a liquid-vapor state. In another non-limiting example, a pressure of the fluid at the gaseous state is 200 psi. In another non-limiting example, the moveable wall of the bellows can both expand and contract. In another non-limiting example, the bellows comprises a stainless steel bellows. In another non-limiting example, the bellows defines a compression chamber of the apparatus. In another non-limiting example, the apparatus also includes a heat exchanger configured to cool the fluid during the compression stroke. In another non-limiting example, the apparatus also includes a pump configured to compress the bellows on the compression stroke. In another non-limiting example, the pump is a hydraulic pump configured to provide hydraulic action to compress the bellows. In another non-limiting example, the apparatus also includes an electric motor configured to drive the pump. In another non-limiting example, the apparatus also includes a feedback circuit configured to sense a load on the bellows and control timing of the compression stroke and the inlet stroke. In another non-limiting example, a system pressure expands the bellows during the inlet stroke.

In another aspect, the present technology relates to a method of compressing a gaseous fluid to a liquid fluid. The method includes introducing the gaseous fluid into an apparatus via an inlet line, the apparatus including (i) a housing, (ii) a bellows disposed within a chamber of the housing, (iii) the inlet line fluidically connected to the bellows, and (iv) an outlet line fluidically connected to the bellows. The method also includes compressing the bellows during a compression stroke; and decompressing the bellows during an inlet stroke. During the inlet stroke, a pressure of the gaseous fluid is less than 350 psi within the bellows and a pressure differential between the bellows and the chamber is less than 25 psi (172.37 kPa). In a non-limiting example, the method also includes cooling the fluid during the compression stroke with a heat exchanger. In another non-limiting example, the method also includes compressing the bellows on the compression stroke with a pump. In another non-limiting example, the method also includes sensing a load on the bellows and controlling timing of the compression stroke and the inlet stroke with a feedback circuit.

In another aspect, the present technology relates to a system for compressing a fluid. The system includes a compression apparatus including: a housing; a bellows disposed within the housing, the bellows including a moveable wall configured to compress and decompress the fluid between a compression stroke and an inlet stroke; an inlet line fluidically connected to the housing; and an outlet line fluidically connected to the housing. The system also includes an accumulator disposed upstream of the compression apparatus and fluidically connected to the inlet line. The system also includes a recycler tank disposed downstream of the compression apparatus and fluidically connected to the outlet line. The system also includes a hydraulic fluid disposed within the housing and surrounding an outer surface of the bellows, wherein the hydraulic fluid maintains a pressure differential of less than 25 psi (172.37 kPa) across the moveable wall during the inlet stroke. In a non-limiting example, the fluid enters the bellows through the inlet line at a gaseous state, and wherein the fluid exits the bellows through the outlet line at a liquid-vapor state. In a non-limiting example, the system also includes a check valve disposed on each of the inlet line and the outlet line.

The above aspects of the technology provide numerous advantages. For example, systems and methods of the present technology allows for convenient and efficient collection of extracts from an extract collection container without leaving substantial residue behind. In particular, various extracts can be collected in removable liners such that a first extract does not substantially contaminate a second extract that is collected within the same extract collection container, but using a new removable liner.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

One of ordinary skill in the art will understand that the drawings primarily are for illustrative purposes and are not intended to limit the scope of the inventive subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is a block diagram of an example bellows compressor system, according to an embodiment of the present disclosure.

FIG. 2 is a block diagram of another example bellows compressor system, according to an embodiment of the present disclosure.

FIG. 3 is a graph showing an example compression cycle of a bellows compressor, according to an embodiment of the present disclosure.

FIG. 4 is a flow chart of an example method for compressing a fluid using a bellows compressor, according to an embodiment of the present disclosure.

FIG. 5A is a block diagram of an example CO₂-based chromatography system with CO₂ recycling, according to an embodiment of the present disclosure.

FIG. 5B is a block diagram of an example CO₂-based extraction system with CO₂ recycling, according to an embodiment of the present disclosure.

The features and advantages of the present disclosure will become more apparent from the detailed description set forth below when taken in conjunction with the drawings.

### DETAILED DESCRIPTION

Following below are more detailed descriptions of various concepts related to, and embodiments of, methodologies, devices, and systems for compressing gaseous CO₂. It should be appreciated that various concepts introduced above and discussed in greater detail below may be implemented in any of numerous ways, as the disclosed concepts are not limited to any particular manner of implementation. For example, various embodiments of the bellows compressor described herein can be implemented within a CO₂-based chromatography system or a CO₂-based extraction system. The bellows compressor can also be used to compress other fluids in addition to CO₂, in some embodiments. As such, examples of specific implementations and applications are provided primarily for illustrative purposes.

As used herein, the term “includes” means includes but is not limited to, the term “including” means including but not limited to. The term “based on” means based at least in part on.

During CO₂-based extraction, an extract is separated from CO₂ within an extract collection container, and the separated extract can be removed from the collection container. In some embodiments, a series of pressurized vessels can be used to separate the different components that are being extracted from a matrix. During CO₂-based chromatography, liquid or partially liquid CO₂ is used as a component of the mobile phase, and the CO₂-based mobile phase is delivered from pumps and carried through the separation column as a pressurized fluid. Typical CO₂-based systems receive highly pressurized CO₂ from CO₂ canisters. Lower pressure collection chambers used in CO₂-based extraction systems allow fractionation at different pressure ranges. However, any gaseous CO₂ retrieved from the fractionation process typically cannot be recycled because it is not in a pressurized liquid or partially liquid state. In some cases, high pressure collection systems that can keep the CO₂ in a liquid state for recycling, but such systems limit the pressure ranges available for fractionation. Example embodiments of the present disclosure can provide a compact and efficient CO₂ compression system for recycling low pressure gaseous CO₂ from a chromatography or extraction system.

In a non-limiting example, a bellows is used to compress CO₂ from the output of a CO₂-based chromatography or extraction system in order to recycle the CO₂ at a liquid or partially liquid state. In some embodiments, the bellows can be a welded steel bellows, and can be configured as a compression chamber to compress CO₂ from approximately 200 psi to approximately 800 or 900 psi. Rather than using a traditional piston compressor, a bellows compressor can be configured to be substantially seal-less and more reliable. This is because a bellows compressor can be configured to have check valves as the only seals needed, which can be made of sapphire or stainless steel, in some embodiments. This reduces the number of seals compared to a piston compressor and also reduces the number of individual moving parts, providing increased reliability and lifespan for the compressor. In a non-limiting example, a heat exchanger can be integrated into the bellows compressor system in order to cool the CO₂, which can experience a rise in temperature as it is compressed. This heat exchanger can facilitate converting the CO₂ from a gaseous state to a liquid or partially liquid state.

In exemplary embodiments, the use of a bellows compressor can raise a number of technical challenges not faced with a conventional piston-based compressor. For example, the operation of a piston-based compressor may utilize a simple rotating cam shaft, or similar device, to move the pistons. With a bellows, however, the actuation can involve hydraulics, such as controlling a hydraulic fluid that surrounds the bellows. Other concerns can include heat dissipation from the bellows compressor and from the hydraulic fluid during operation.

In a non-limiting example, using a bellows compressor can provide significant benefits compared to other compression systems. Because the bellows itself acts as a compression chamber, a larger amount of CO₂ can be compressed in each compression stroke, as compared with other types of compression systems. For example, in a piston-based compressor a larger portion of the compressor is taken up by mechanical components, which can result in reduced yield. Another possible benefit provided by using a bellows compressor is increased lifespan of the apparatus. In a non-limiting example, a suitable bellows compressor does not use dynamic seals, such as those used in a piston compressor that can wear out and need replacement. This can reduce the need for maintenance and increase the lifespan of the system.

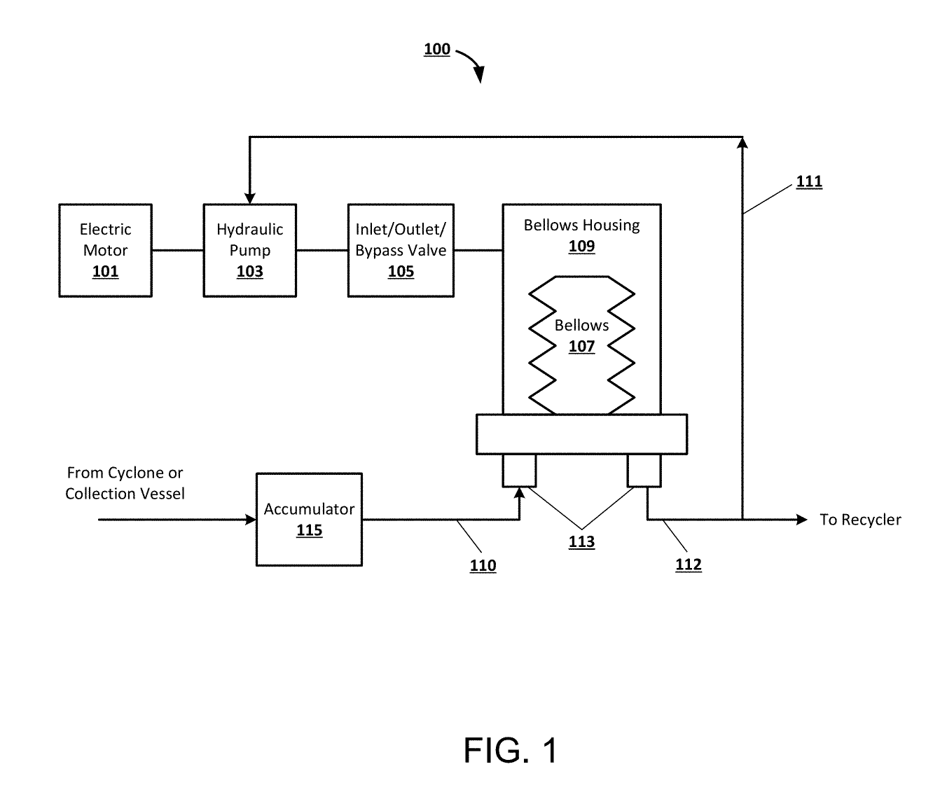

FIG. 1 is a block diagram of an example bellows compressor system 100, according to an embodiment of the present disclosure. In a non-limiting example, the system 100 can include a bellows 107 within a bellows housing 109. A hydraulic pump 103 can be configured to provide the hydraulic power required to compress the bellows 107 on a compression stroke, which can expand on an inlet stroke under the system pressure. The bellows housing 109 can be configured to hold a hydraulic fluid in some embodiments. The hydraulic fluid can be configured, in some embodiments, to maintain a specific pressure differential across the wall of the bellows 107 during an inlet stroke. In a non-limiting example, the pressure differential can be maintained below 25 psi (172.37 kPa). An electric motor 101 can be used, in some embodiments, to drive the hydraulic pump 103, and a feedback circuit 111 can help control the timing of the compression inlet stroke. The valve 105 can include an inlet position, outlet position, and a bypass position. The bellows compressor system 100 can also include check valves 113 configured to control the flow of CO₂ to and from the bellows 107. The check valves 113 control the flow of CO₂ through the fluid inlet line 110 and the fluid outlet line 112. In a non-limiting example, low pressure CO₂ can be received from a cyclone or collection vessel at an accumulator 115, and this CO₂ can be directed to the bellows 107 for compression. The check valves 113 can open to allow low pressure CO₂ to enter the bellows 107 from the accumulator 115 during an inlet stroke. Once the bellows 107 is filled with low pressure gaseous CO₂, a compression stroke can compress the CO₂ within the bellows 107 and the check valves 113 can allow pressurized CO₂ to exit the bellows 107 to a recycler in a liquid or partially liquid-vapor state.

In a non-limiting example, the design of the bellows 107 includes a relatively thin wall design, which makes it flexible and thus eliminates the need for dynamic seals. Due to this thin wall design, a large pressure differential across the bellows wall may cause problems. Thus, in order to maintain a suitably low pressure differential across the wall of the bellows 107, a hydraulic fluid can be used to surround the outside of the bellows within the housing 109. The construction of the housing 109, in some embodiments, can be configured to withstand the operating pressures of the bellows compressor system 100. In a non-limiting example, the operating pressure of the bellows 107 can be about 200 psi. However, this operating pressure may depend on many factors including temperature, volume, flow rate, and efficiency of the system. The size and volume of the bellows 107 may also vary based on the needs of particular embodiments.

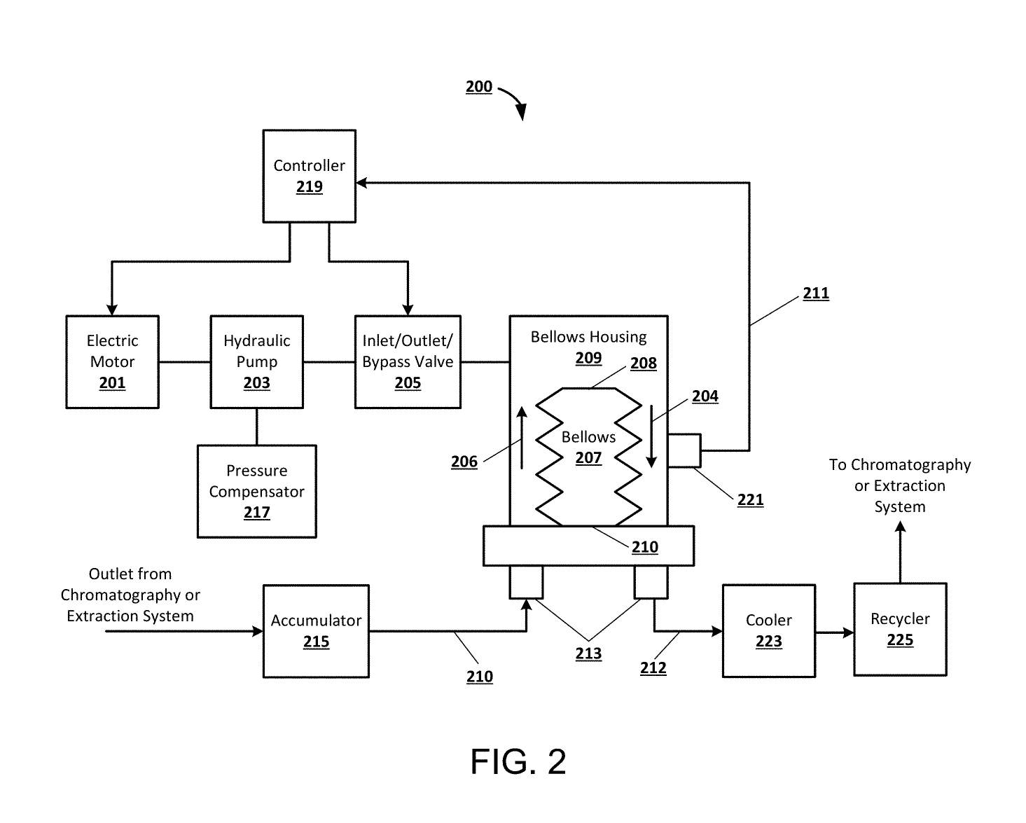

FIG. 2 is a block diagram of another example bellows compressor system 200, according to an embodiment of the present disclosure. In a non-limiting example, the system 200 can include a bellows 207 within a bellows housing 209. A hydraulic pump 203 can be configured to provide the hydraulic power required to compress the bellows 207 on a compression stroke, which can expand on an inlet stroke under the system pressure. In a non-limiting example, during a compression stroke the bellows 207 moves in the direction 204 such that a first movable end or portion 208 of the bellows moves towards a second portion 210 of the bellows 207. During an inlet stroke, the first portion 208 of the bellows 207 moves in the direction 206 away from the second portion 210, thus expanding the bellows 207. The bellows housing 209 can be configured to hold a hydraulic fluid in some embodiments. An electric motor 201 can be used, in some embodiments, to drive the hydraulic pump 203, and a valve 205 can control flow of the hydraulic pump to the bellows housing 209. The valve 205 can include an inlet position, outlet position, and a bypass position. In a non-limiting example, a controller 219 can be used to control the operation of the electric motor 201 and the valve 205. The controller can also receive feedback 211 from a transducer 221 associated with the bellows 207, and this feedback 211 can be used to control the timing of the compression and inlet stroke.

In some embodiments, the hydraulic pump 203 can be a variable flow and variable pressure pump. The output pressure of the hydraulic pump 203 can be set, in some embodiments, by a pressure compensator 217, such that it is greater than the pressure of a recycler tank 225. The pump flow can be driven by the pressure compensator 217 once a desired pressure is reached, and the hydraulic pump 203 can adjust the bellows stroke to a flow rate that maintains that desired pressure.

The bellows compressor system 200 can also include check valves 213 configured to control the flow of CO₂ to and from the bellows 207. The check valves 213 control the flow of CO₂ through the fluid inlet line 210 and the fluid outlet line 212. In a non-limiting example, low pressure CO₂ can be received from the output of a CO₂-based chromatography or extraction system at an accumulator 215, and this CO₂ can be directed to the bellows 207 for compression. The check valves 213 can open to allow low pressure CO₂ to enter the bellows 207 from the accumulator 215 during an inlet stroke. Once the bellows 207 is filled with low pressure gaseous CO₂, a compression stroke can compress the CO₂ and the check valves 213 can allow pressurized CO₂ to exit the bellows 207 to a cooler 223 and the recycler tank 225 in a liquid or partially liquid-vapor state. In some embodiments, the cooler 223 can include a heat exchanger located at or near the bellows 207 or along the fluid outlet line 212.

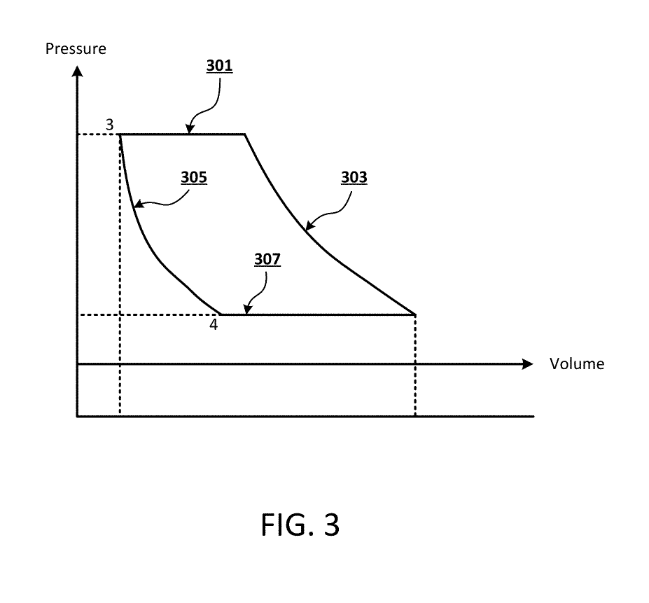

FIG. 3 is a graph showing an example compression cycle of a bellows compressor, according to an embodiment of the present disclosure. In a non-limiting example, isobaric expansion is illustrated at 301, where V₂/T₂=V₃/T₃. Likewise, polytropic compression is illustrated at 303, where P₁*V₁ⁿ=P₂*V₂ⁿ. In a non-limiting example, the value “n” varies between approximately 1 and 1.28 during polytropic compression. Polytropic expansion is illustrated at 305, where P₃*V₃ⁿ=P₄*V₄ⁿ. Similar to polytropic compression, the value “n” can vary between approximately 1 and 1.28 during polytropic expansion, in some embodiments. Isobaric induction is illustrated at 307, where V₄/T₄=V₁/T₁. In physical reality, this can be a 3 dimensional graph, where a third axis can be drawn, labeled with a unit of temperature. This axis is perpendicular to the first two axes. The temperature of the fluid then moves into and out of the page as described by the polytropic exponent during the dynamic compression and expansion events. Additionally, the isobaric expansion and compression described by the graph are approximations; in physical reality, the loss of static pressure due to expansion of the CO2 causes a small pressure drop, which appears as a gentle slope on the pressure-volume(-temperature) graph.

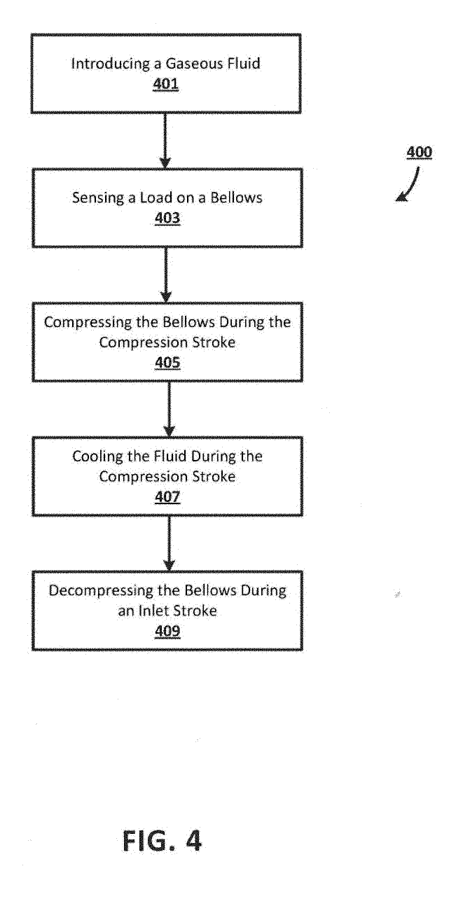

FIG. 4 is a flow chart of an example method 400 for compressing a fluid using a bellows compressor, according to an embodiment of the present disclosure. It will be appreciated that the method can be programmatically performed, at least in part, by one or more computer-executable processes executing on, or in communication with, one or more servers or other computing devices. In step 401, a gaseous fluid, such as CO₂, is introduced into a bellows via an inlet line. The bellows can be located within a chamber inside a bellows housing, as discussed above, and the bellows can be connected to the fluid inlet line and a fluid outlet line.

In step 403, a feedback circuit or loop senses the load on the bellows and assist in controlling the timing of the compression stroke and inlet stroke of the bellows, as discussed above. In step 405, the bellows is compressed during a compression stroke. In a non-limiting example, the bellows can be surrounded by a hydraulic fluid within the chamber of the bellows housing, and the bellows can be compressed by controlling this hydraulic fluid.

In step 407, the compressed fluid (i.e., compressed CO₂ in a liquid or partial liquid state) is cooled during the compression stroke. As discussed above, unwanted heat can be generated when compressing CO₂ to a liquid or partially liquid state, so it can be beneficial to cool the CO₂ during a compression stroke. In some embodiments, the CO₂ can be cooled by cooling the hydraulic fluid, cooling all or a portion of the bellows, or using a heat exchanger located at or near the bellows.

In step 409, the bellows is decompressed during an inlet stroke after the compressed fluid (i.e. the compressed CO₂) exits the bellows. As discussed above, compressed CO₂ can be directed to a recycler tank for future use, and additional low pressure gaseous CO₂ can fill the bellows during an inlet stroke.

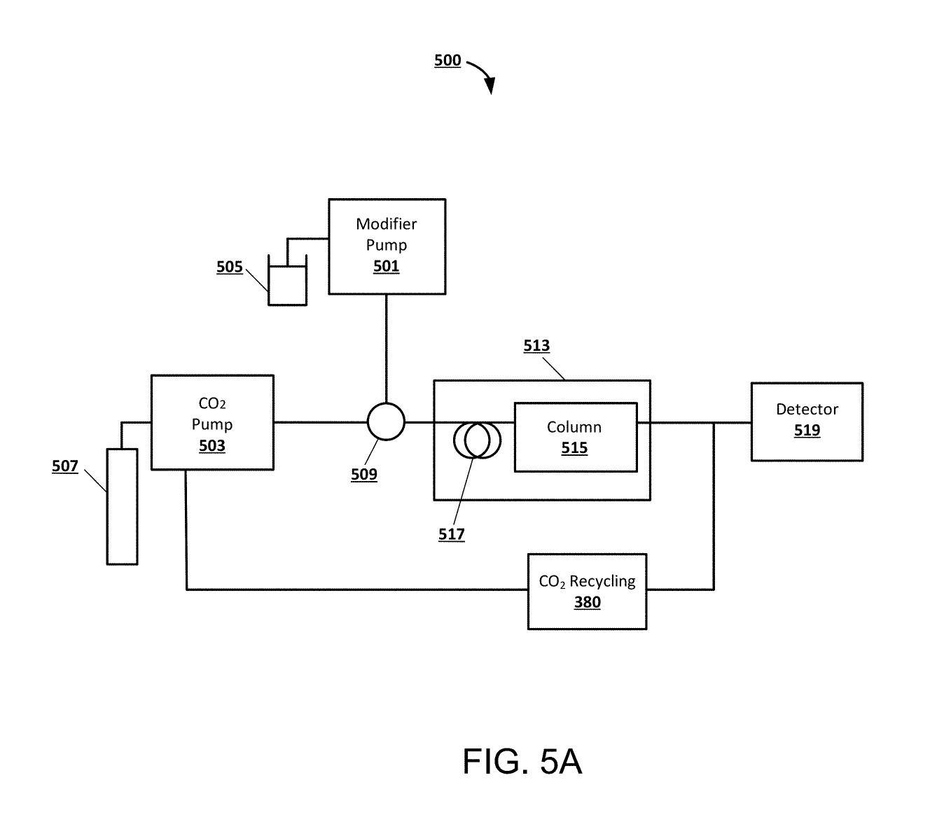

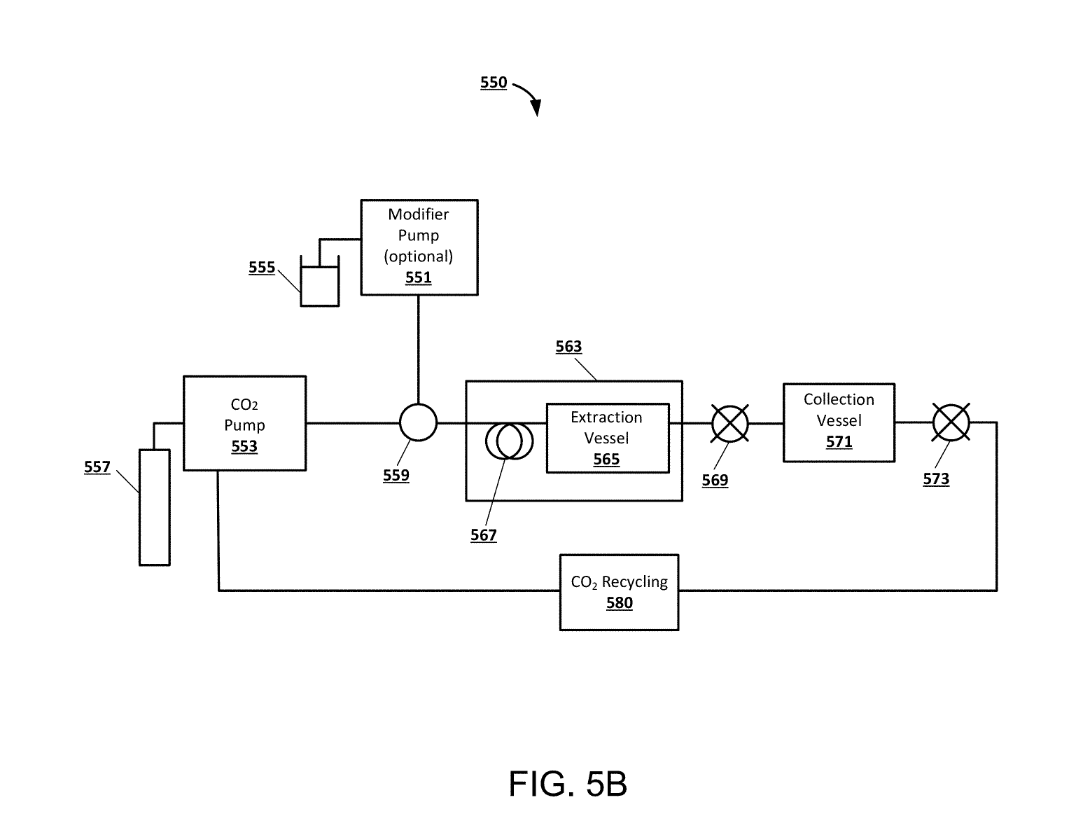

FIG. 5A is a block diagram of an example CO₂-based chromatography system 500 with CO₂ recycling, according to an embodiment of the present disclosure. In this example, a modifier pump 501 is used to pump a liquid modifier from a reservoir 505 to a mixer 509, and a CO₂ pump 503 is used to pump CO₂ from a CO₂ container or reservoir 507 to the mixer 509. In this technological field, CO₂ pumps are pumps that are able to adequately pump CO₂ and often require cooling to maintain the CO₂ in a liquid-like state. The liquid modifier and CO₂ mixture can be injected to a CO₂-based chromatography column 515 located within a column oven 513, which includes preheating elements 517. Downstream of the column 515, an analyte of interest can be separated from the CO₂ and diverted to a detector 519, while the CO₂ can be directed to a CO₂ recycling system 380, such as the ones described above in FIGS. 1-2. In some embodiments, separating the CO₂ from the analyte involves depressurizing the CO₂ into a gaseous state, and the recycling system 380 is configured to compress the CO₂ using a bellows compressor back into a liquid or partial liquid state. Once the CO₂ has been pressurized to a liquid or partially liquid state, the CO₂ can be directed to the CO₂ pump 503 and thus recycled back into the system. In other embodiments, the CO₂ can be held in a recycler tank for future use.

FIG. 5B is a block diagram of an example CO₂-based extraction system 550 with CO₂ recycling, according to an embodiment of the present disclosure. In this example, an optional modifier pump 551 is used to pump a liquid modifier from a reservoir 555 to a mixer 559 for combination with CO₂ delivered from a CO₂ pump 553 connected to CO₂ tank 557. From the mixer 559, extraction fluid (i.e., combined modifier with CO₂ or 100% CO₂) is provided to an extraction thermal management system 563 surrounding extraction vessel 565. The extraction thermal management system 563 allows for control over the temperature of the extraction vessel 565 and can include preheating elements 567 to allow for heating of the extraction fluid. Thermal management system 563 can also provide direct or indirect heating/cooling to the body of extraction vessel 565. The extraction system 550 also includes a back pressure regulator (bpr) 569 located directly downstream of the extraction vessel 565 to control system pressure. A collection vessel 571 is positioned downstream of the bpr 569 and is followed by a collection bpr 573 for controlling the pressure within the collection vessel 571. From the collection bpr 573, used extraction fluid can be separated and the CO₂ portion can be directed to a CO₂ recycling system 580, such as the recycling systems discussed above in FIGS. 1-2. Once the CO₂ has been pressurized to a liquid or partially liquid state using the CO₂ recycling system 580, the CO₂ can be directed back to the CO₂ pump 553 and thus recycled back into the system.

In describing example embodiments, specific terminology is used for the sake of clarity. For purposes of description, each specific term is intended to at least include all technical and functional equivalents that operate in a similar manner to accomplish a similar purpose. Additionally, in some instances where a particular example embodiment includes system elements, device components or method steps, those elements, components or steps can be replaced with a single element, component or step. Likewise, a single element, component or step can be replaced with a plurality of elements, components or steps that serve the same purpose. Moreover, while example embodiments have been shown and described with references to particular embodiments thereof, those of ordinary skill in the art will understand that various substitutions and alterations in form and detail can be made therein without departing from the scope of the disclosure. As one particular example, while the technology has been described with respect to flow streams/extraction solvents containing CO₂, it is possible that CO₂ could be replaced with other fluids including xenon, nitrogen, SF6, CFCs, FCs, nitrous oxide, argon, and possibly water under supercritical conditions. Further still, other aspects, functions and advantages are also within the scope of the disclosure.

Example flowcharts are provided herein for illustrative purposes and are non-limiting examples of methods. One of ordinary skill in the art will recognize that example methods can include more or fewer steps than those illustrated in the example flowcharts, and that the steps in the example flowcharts can be performed in a different order than the order shown in the illustrative flowcharts.

What is claimed is:

1. An apparatus for compressing a fluid, comprising:
a housing;
a bellows disposed within the housing, the bellows including a moveable wall configured to compress and decompress the fluid between a compression stroke and an inlet stroke;
an inlet line fluidically connected to the bellows;
an outlet line fluidically connected to the bellows; and
a hydraulic fluid disposed within the housing and surrounding an outer surface of the bellows, wherein the hydraulic fluid maintains a pressure differential of less than 25 psi (172.37 kPa) across the moveable wall during the inlet stroke.

2. The apparatus of claim 1, wherein the fluid is CO₂.

3. The apparatus of claim 1, wherein the fluid enters the bellows through the inlet line at a gaseous state, and wherein the fluid exits the bellows through the outlet line at a liquid-vapor state.

4. The apparatus of claim 3, wherein a pressure of the fluid at the gaseous state is 200 psi.

5. The apparatus of claim 1, wherein the moveable wall of the bellows can both expand and contract.

6. The apparatus of claim 1, wherein the bellows comprises a stainless steel bellows.

7. The apparatus of claim 1, wherein the bellows defines a compression chamber of the apparatus.

8. The apparatus of claim 1, comprising a heat exchanger configured to cool the fluid during the compression stroke.

9. The apparatus of claim 1, comprising a pump configured to compress the bellows on the compression stroke.

10. The apparatus of claim 9, wherein the pump is a hydraulic pump configured to provide hydraulic action to compress the bellows.

11. The apparatus of claim 9, comprising an electric motor configured to drive the pump.

12. The apparatus of claim 1, comprising a feedback circuit configured to sense a load on the bellows and control timing of the compression stroke and the inlet stroke.

13. The apparatus of claim 1, wherein a system pressure expands the bellows during the inlet stroke.

14. A method of compressing a gaseous fluid to a liquid fluid, comprising:
introducing the gaseous fluid into an apparatus via an inlet line, the apparatus including (i) a housing, (ii) a bellows disposed within a chamber of the housing, (iii) the inlet line fluidically connected to the bellows, and (iv) an outlet line fluidically connected to the bellows;
compressing the bellows during a compression stroke; and
decompressing the bellows during an inlet stroke,
wherein during the inlet stroke a pressure of the gaseous fluid is less than 350 psi within the bellows and a pressure differential between the bellows and the chamber is less than 25 psi (172.37 kPa).

15. The method of claim 14, comprising cooling the fluid during the compression stroke with a heat exchanger.

16. The method of claim 14, comprising compressing the bellows on the compression stroke with a pump.

17. The method of claim 14, comprising sensing a load on the bellows and controlling timing of the compression stroke and the inlet stroke with a feedback circuit.

18. A system for compressing a fluid, comprising:
a compression apparatus including:
a housing;
a bellows disposed within the housing, the bellows including a moveable wall configured to compress and decompress the fluid between a compression stroke and an inlet stroke;
an inlet line fluidically connected to the housing; and
an outlet line fluidically connected to the housing;
an accumulator disposed upstream of the compression apparatus and fluidically connected to the inlet line;
a recycler tank disposed downstream of the compression apparatus and fluidically connected to the outlet line; and
a hydraulic fluid disposed within the housing and surrounding an outer surface of the bellows, wherein the hydraulic fluid maintains a pressure differential of less than 25 psi (172.37 kPa) across the moveable wall during the inlet stroke.

19. The system of claim 18, wherein the fluid enters the bellows through the inlet line at a gaseous state, and wherein the fluid exits the bellows through the outlet line at a liquid-vapor state.

20. The system of claim 18, further comprising a check valve disposed on each of the inlet line and the outlet line.
